(19) United States
(12) Patent Application Publication
(10) Pub. No.: US 2026/0025448 A1
(43) Pub. Date: Jan. 22, 2026

(54) SLIDABLE LOCKING BUTTONS FOR ELECTRONIC DEVICE

(71) Applicant: Apple Inc., Cupertino, CA (US)

(72) Inventors: Melissa Fung, Cupertino, CA (US); James A. Bertin, Saratoga, CA (US); Benjamin J. Pope, Woodside, CA (US); Richard H. Dinh, Cupertino, CA (US); Amith lyer, Cupertino, CA (US); Xiaotong Bu, Shenzhen (CN); Matthew J. Cheung, Castro Valley, CA (US); Michael Y. Zhang, Cupertino, CA (US)

(21) Appl. No.: 18/777,487

(22) Filed: Jul. 18, 2024

(51) Int. Cl. H04M 1/02

(52) U.S. Cl. CPC H04M 1/026

(57) ABSTRACT

This disclosure describes an input button system that may be incorporated in an electronic device, such as a mobile phone. The input button system may include a button assembly that is slidable to a first position or to a second position. At the first position, the button assembly may be actuatable in response to an input force. At the second position, the button assembly is inhibited from actuating in response to the force. The button assembly may include a slidable assembly having a button cap and a spring member, and which is configured to slide and/or actuate (e.g., translate). The button assembly may also include an actuation member having at least one post and a cross member. The actuation member may be configured to actuate and may not slide. The spring member applies a retention force to the actuation member and may provide a haptic output in response to sliding.

### TECHNICAL FIELD

Embodiments described herein relate to electronic devices, and more particularly, to input systems for electronic devices.

### BACKGROUND

Modern consumer electronic devices take many shapes and forms, and have numerous uses and functions. For example, a mobile phone or tablet computer may include a touch-sensitive display for providing graphical outputs and for accepting touch inputs, wireless communications systems for connecting with other devices to send and receive data and voice content, cameras for capturing photographs and videos, and so forth. Input systems may provide user control of certain device functions and settings.

### SUMMARY

In some embodiments described herein, a mobile phone may include a housing defining a side surface of the mobile phone and an input button system positioned along the side surface of the housing and configured to receive an input force. The input button system may include a button assembly having an actuation member and a slidable assembly. The actuation member may include a post extending through the housing and a cross member coupled to the post, the cross member defining a first retention feature and a second retention feature. The slidable assembly may be coupled to the actuation member and may be configured to slide, relative to the actuation member, between a first position in which the input button system is actuatable in response to the input force and a second position in which the input button system is inhibited from actuating in response to the input force. The sliding assembly may include a button cap defining a user input surface of the button assembly and a spring member coupled to the button cap and defining a protruding portion. The protruding portion may be configured to: engage with the first retention feature of the actuation member to releasably retain the slidable assembly in the first position and engage with the second retention feature of the actuation member to releasably retain the slidable assembly in the second position.

In some cases, the housing defines a button cavity having a bottom surface, the button cap, the spring member, and the cross member are positioned at least partially within the button cavity, the bottom surface of the button cavity defines a recess, the button cap defines a protrusion, and actuation of the input button system corresponds to a translational input. At the first position, the protrusion may be configured to interfere with the bottom surface to inhibit translation and align with the recess to allow translation. In some examples, the cross member defines a first end and a second end, and the button cap defines a wall extending about an outer periphery of the cross member. In this example, at the first position, the wall abuts the first end of the cross member and defines a first gap with respect to the second end of the cross member and, at the second position, the wall abuts the second end of the cross member and defines a second gap with respect to the first end of the cross member.

In some variations described herein, the button cap defines a sliding surface opposite a user interface surface and the cross member is captured between the sliding surface and the spring member. In some cases, the first retention feature defines a first depression, the second retention feature defines a second depression, in the first position, the protruding member engages with the first depression, the protruding member is configured to deform along a surface defined between the first and second depressions of the cross member during a sliding motion, and, in the second position, the protruding member engages with the second depression.

In some embodiments, in response to a threshold sliding force applied to the button cap, the slidable assembly may be configured to slide from the first to the second position, the sliding including causing the protruding member to disengage from the first depression and to engage the second depression. In some examples, the protruding member is positioned at a central region of the spring member and the spring member is welded to the button cap.

According to some embodiments described herein, an electronic device may include a housing and a button assembly. The housing may include a metal material. The button assembly may be positioned along a side of the housing and include an actuation member configured to actuate a switch internal to the housing and a slidable assembly positionable in a first position in which the button assembly is translatable with respect to the housing and a second position in which the button assembly is non-translatable with respect to the housing. The slidable assembly may be configured to slide between the first position and the second position. The slidable assembly may include a button cap positioned over the actuation member and a spring member fixed to the button cap and configured to apply a retention force to the actuation member to resist motion of the slidable assembly between the first position and the second position.

In some cases, the button cap may define a user input surface configured to receive a sliding force, the actuation member may include a cross member defining a first retention feature configured to releasably engage with the spring member in the first position and a second retention feature configured to releasably engage with the spring member in the second position. The spring member may be configured to disengage the first retention feature of the cross member at the first position and engage the second retention feature of the actuation member at the second position in response to the sliding force exceeding a threshold retention force between the spring member and the first retention feature.

In some examples, the actuation member may include a post operable to actuate a dome switch within the housing and a cross member coupled to the post. The cross member may be captured between the button cap and the spring member. The cross member may releasably retain the spring member in either the first position or the second position and the spring member may be configured to produce a tactile output in response to being moved from the first position to the second position. In some cases, the cross member may be fixed along a sliding direction with respect to the housing.

In some variations, the electronic device may include a position sensing system. The position sensing system may have a tag coupled to the button cap and a sensing element positioned within the housing and configured to detect a position of the button cap based at least in part on a position of the tag relative to the sensing element. The position sensing system may be operably coupled to a processor and, in response to the sensing element determining the position of the button cap, the processor may be configured to cause display of a graphical indicator in a display of the electronic device.

Some embodiments described herein are directed to a mobile electronic device having a housing and a button assembly. The housing may define an opening. The button assembly may include an actuation member configured to actuate a switch internal to the housing and a slidable assembly. The actuation member may include a post extending through the opening and a cross member defining a first engagement feature and a second engagement feature. The slidable assembly may be slidable between a first position and a second position and coupled to the actuation member. The slidable assembly may include a button cap defining a user input surface and slidably coupled to the cross member and a spring member. The button cap may be configured to, when the slidable assembly is in the first position, cause the actuation member to actuate the switch in response to a force input at the user input surface, and, when the slidable assembly is in the second position, prevent actuation of the actuation member in response to the force input at the user input surface. The spring member may be slidably coupled to the button cap and may define a protruding portion configured to releasably couple to the first engagement feature when the slidable assembly is in the first position and to the second engagement feature when the slidable assembly is in the second position.

In some cases, the button assembly is bistable and the spring member is configured to snap the button cap to either the first position or the second position. In some embodiments, in response to a sliding input at the user input surface to transition from the first position to the second position, the protruding portion may be configured to deflect to disengage the first engagement feature and restore to engage the second engagement feature. The button cap may define a channel opposite a user interface surface, the cross member may extend into the channel, and the mobile electronic device may include a lubricant at least partially filling the channel and lubricating an interface between the cross member and the button cap.

In some examples, the button assembly is positioned within a button cavity defined by the housing and a bottom surface of the button cavity defines a raised portion configured to prevent the button cap from pressing in the second position. In some embodiments, the mobile electronic device may include a flex circuit, the button cap comprises an electronic component layer which may be configured to detect an input from a user, the electronic component layer may be operably coupled to the flex circuit, and the flex circuit may be configured to receive a signal from the electronic component layer.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts an example electronic device including a button assembly, such as described herein.

FIGS. 2A-2C depict a plan view and a cross-sectional view of the button assembly, such as described herein.

FIG. 3A depicts an exploded view of an example button assembly.

FIGS. 3B and 3C depicts a bottom view of an example button assembly.

FIGS. 4A-4C depict example cross sectional views of examples input button systems incorporating the button assembly.

FIGS. 5A-5B depict a cross sectional view of an example input button system with a position sensor.

FIG. 6 depicts a detail view of a spring member and actuation member interface.

FIG. 7 depicts a bottom view of an example button assembly.

FIG. 8A depicts a cross-sectional view of an example button assembly.

FIG. 8B shows an cross-sectional view of an example button assembly.

FIG. 9 depicts example components of the electronic device.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to input button systems that may be incorporated into an electronic device. In particular, the example input button systems described herein include a slidable component (such as a button cap) having a first position and a second position. In a first position, the button may be actuatable in response to a user input force (e.g., pressing the button). In the second position, the button cap (or other structure) inhibits actuation of the button. The button assembly may include a detent system that slidably retains the button cap in either position, and optionally provides tactile feedback to a user to indicate when the button cap has been moved out of and/or into the available positions.

Buttons and other input systems in electronic devices provide users with convenient ways to access different functions on their devices. For example, buttons may be used as a volume control for the device, an on/off or power button, a mode control button, a volume select button, a quick-action button (e.g., to trigger a camera or other function of the device), and the like. Often, buttons in electronic device are positioned along a side of the device for convenient access. However, these buttons may be accidentally pressed during device handling (e.g., placement in a pocket). In some cases, accidental pressing of the button may trigger an unwanted or unexpected device action (e.g., launching a camera application or capturing a photo, turning a device on or off, changing a device volume or other setting, or the like, which may result in memory being taken up, drainage of the battery, and the like).

An input button system, such as described herein, may include a slidable assembly that can slide or toggle between a first position and a second position. In the first position (e.g., an unlocked position), the button can be actuated by a user (e.g., translated with respect to the housing of the electronic device). In the second position (e.g., a locked position), the button resists actuation by the user (e.g., due to one or more mechanical or electrical components inhibiting depression of the button with respect to the housing). The button may be configured to prevent an accidental pressing in the locked position while also allowing a user to easily and quickly toggle to a second position to use the functionality of the button.

The slidable assembly of a button assembly, or an input button system more generally, may include a button cap and a spring member. The button cap has a user input surface that can receive sliding and pressing inputs from the user. The slidable assembly may also include a spring member that enables the button assembly to releasably retain the slidable assembly in the first position or the second position. In some cases, the spring member may also be configured to enable a clicking or snap of the slidable assembly to either position. More specifically, the spring member may include a deformable portion that provides a resistance force to retain the slidable assembly in place (e.g., prevent accidental sliding, help align the button assembly). In some cases, the slidable assembly may be bistable and the geometry of the slidable assembly and an actuation member interface may prevent the button assembly from being stuck in an intermediate position.

The button assembly may additionally include an actuating member to which the slidable assembly is slidably coupled. The actuation member may be operably coupled with respect to electronic components within the device, such as switches, flexible circuits, shear plates, sensing systems, and the like. In some examples, the actuating member is configured so that it translates along a press direction when pressed (e.g., perpendicular to the input surface of the button cap), but does not slide or otherwise translate with respect to a housing component of the electronic device (e.g., the actuating member does not slide along with the button cap). More generally, the actuation member may be configured to be actuatable when the slidable assembly is in the second position, such that a press or force input moves the actuation member to actuate the electronic components (e.g., thereby activating a predetermined function of the electronic device, triggering a haptic response, etc.). The actuation member may include at least one post and a cross member. The post may extend into the housing of the electronic device (e.g., through an opening of the housing) and interface with one or more members which actuate a sensing system (e.g., a dome switch, a magnetic switch, force sensor, translation sensor, or the like), within the electronic device. The cross member may be coupled to the post and may extend lengthwise along a surface of the housing. A portion of the cross member may be captured between the button cap and the spring member of the slidable assembly and may include retention features (e.g., depressions, slots) that engage the protruding portion of the spring member, allowing the spring member to apply a retention force with respect to the cross-member—thereby inhibiting accidental sliding.

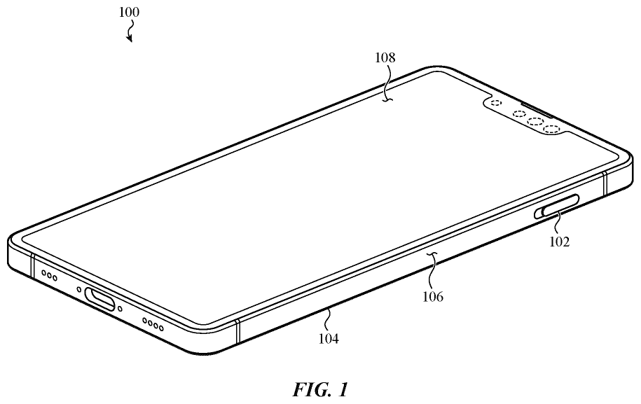

These foregoing and other embodiments are discussed below with reference to FIGS. 1-9. However, those skilled in the art will readily appreciate that the detailed description given herein with respect to these figures is for explanation only and should not be construed as limiting.

FIG. 1 depicts a perspective view of an example electronic device 100. The device 100 may include a slidable button 102 that can be toggled or moved between a first and a second position (or a component or assembly of the button 102 may be toggled or moved between a first and second position). While an electronic phone is shown in the FIG. 1, the slidable button 102 may be incorporated in other types of electronic devices, including tablets, laptops, watches, AR/VR headsets, headphones, digital media players, wearable devices, and the like.

The electronic device may have a housing 104 which defines a side of the electronic device 100. The housing 104 may be formed from a polymer material, a metal material, such as titanium, stainless steel, aluminum, metal alloys, and/or any combination of materials. The housing 104 may be formed from multiple metal members and coupled together via a polymer member (e.g., an injection-molded portion), or may be assembled through any suitable method. In some cases, the housing 104 may be a monolithic material.

Generally, the housing 104 is configured to house internal components of the device, including batteries, processors, sensors, and the like. The housing 104 may also be configured to provide mechanical protection to the internal components and to protect partially- or externally-facing components, such as a display assembly including a cover 108. The cover 108 may be partially positioned within the housing and may define a front surface of the device. The cover 108 may be glass, sapphire, polymer, or any suitable material, as may be known to one of skill in the art. More generally, the display stack of the display assembly may include a liquid crystal display (LCD), an organic light emitting diode display (OLED), or any suitable display technology. The display assembly outputs a graphical user interface of the device and may include other sensors, such as a fingerprint sensor, touch sensors, force sensors, and the like. The touch and/or force sensors may detect various types of user including swipes, taps, and other gestures. More generally, the display assembly can be configured to output a particular user interface in response to the button 102 being pressed, in response to the button 102 being locked at the first position, and the like.

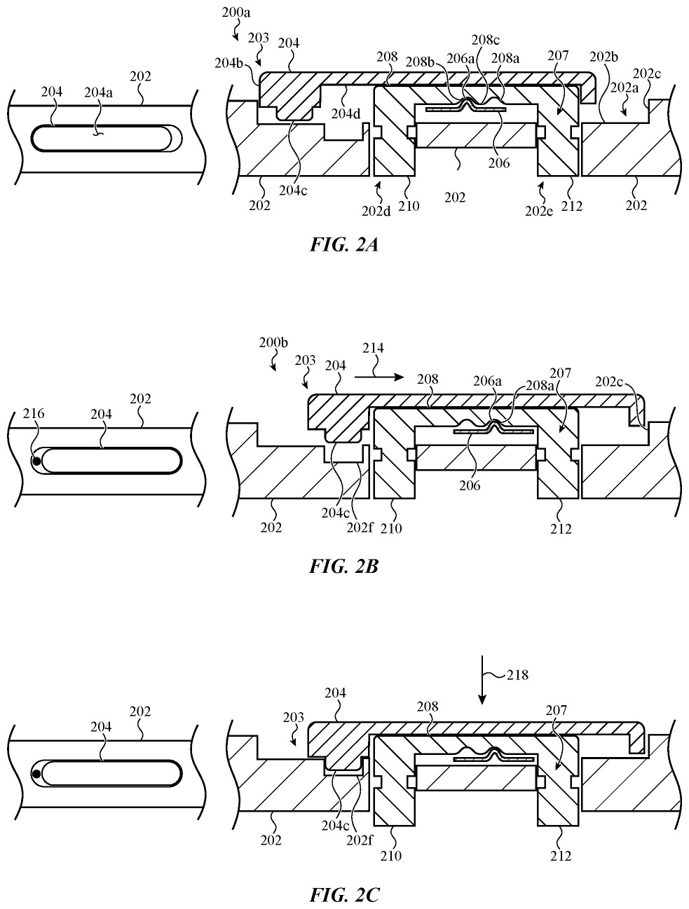

The electronic device 100 may also include rear-facing components (not shown), such as cameras, IR sensors, and the like. The housing 104 may also define one or more button cavities and one or more openings through which portions of the button assembly are mounted. In some cases, the button 102 may sit at least partially within the button cavity (see FIGS. 2A-2C) and partially protrude from the button cavity. As depicted in FIG. 1, the button cavity may contour to a general outline of the button assembly 102 and define the sliding limits (e.g., axial movement) of the button assembly 102.

FIGS. 2A-2C depict plan views of the button assembly 102 from FIG. 1 along side cross-sectional views of the button assembly 102. First, FIG. 2A shows a button assembly 200a in a locked position (e.g., second position). The button assembly 200a may be positioned, at least partially, within a housing 202 of an electronic device, such as electronic device 100 of FIG. 1. The housing 202 may define a button cavity 202a in which the button assembly, or a portion thereof, sits. The button cavity 202a may be formed within the housing 202 and may include a bottom surface 202b and a sidewall 202c, which define a boundary of the button cavity 202a.

The button assembly 200a may include a slidable assembly 203. In some examples, the slidable assembly includes a button cap 204. The button cap 204 may be configured to slide from a first end of the button cavity 202a to a second end of the button cavity 202a. More generally, the button cap 204 may define an elongate member that slides along a side of the housing 202. The button cap 204 is externally-facing with respect to the electronic device may define a user-interface surface 204a. In some examples, the button cap 204 protrudes with respect to the housing 202 (e.g., the user-interface surface 204a is proud of the housing 202). In this configuration, a user's finger can latch on to or otherwise engage a protruding portion of the button cap 204 to slide the button assembly to the first and/or to the second position. In some embodiments, the button cap 204 may define a side surface 204b, which can be configured to at least partially occlude other components of the button assembly 200a from view and/or to interface with the sidewall 202c of the housing 202 to prevent further sliding motion of the button cap 204. For example, as shown in the plan view, in a locked position, the button cap 204 may be slid towards a left side of the housing 202. At this position, the button cap 204 is prevented from further sliding movement by the contact or abutment of the side surface 204b of the button cap 204 with the sidewall 202c of the housing 202. When the button cap 204 is slid to one side, it may define a gap with respect to an opposite side. This gap may define the travel direction of sliding of the slidable assembly. Generally, the side surface 204b may be defined by a wall of the button cap 204. In an assembled state, the wall of the button cap extends around an outer periphery of the cross member 208.

As depicted in FIGS. 2A and 2B, a button assembly has two positions: a first position and a second position. A user can slide this slidable assembly 203 (and, specifically, the button cap 204) to transition between the positions shown in FIGS. 2A and 2B. In FIG. 2A, the slidable assembly is in a second position (e.g., locked). At this position, the button assembly is inhibited from being actuated. In this case, the button cap 204 includes protrusions which interfere with the housing, thereby preventing the button cap 204 (and thus the rest of the button assembly) from translating. In FIG. 2B, the slidable assembly 203 is in the first position (e.g., the button cap 204 and the spring member 206 are shifted towards the right of the page). In this second position, the button assembly is unlocked and the button assembly 200b can be actuated. In this position, the protrusion (which prevented movement of the button cap 204 in the first position) is aligned with respect to a recess in the housing. Thus, the protrusion does not interfere with the actuation of the button assembly. An example button actuation (pressed button assembly) is depicted in FIG. 2C.

The button cap 204 may be formed from a metal material, such as stainless steel, titanium, aluminum, metal alloys, composites, polymers, glass, glass ceramics, and/or other combination of materials. In some cases, the button cap 204 may be a monolithic piece. In other examples, the button cap 204 may be an assembly of components, including electronic components, sensors, and the like.

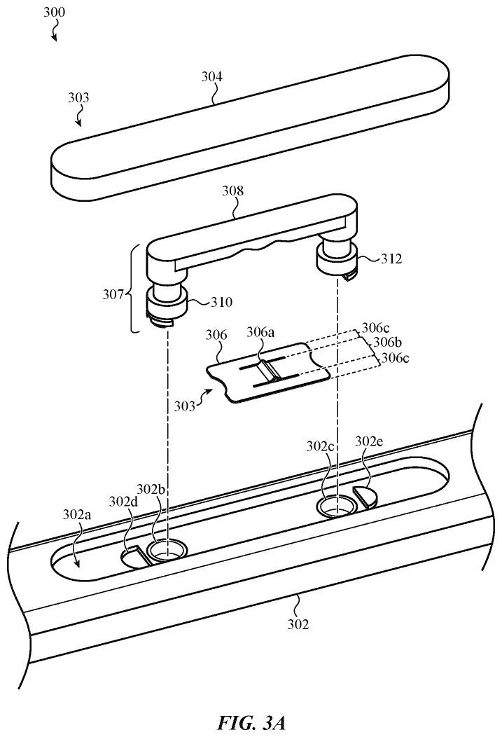

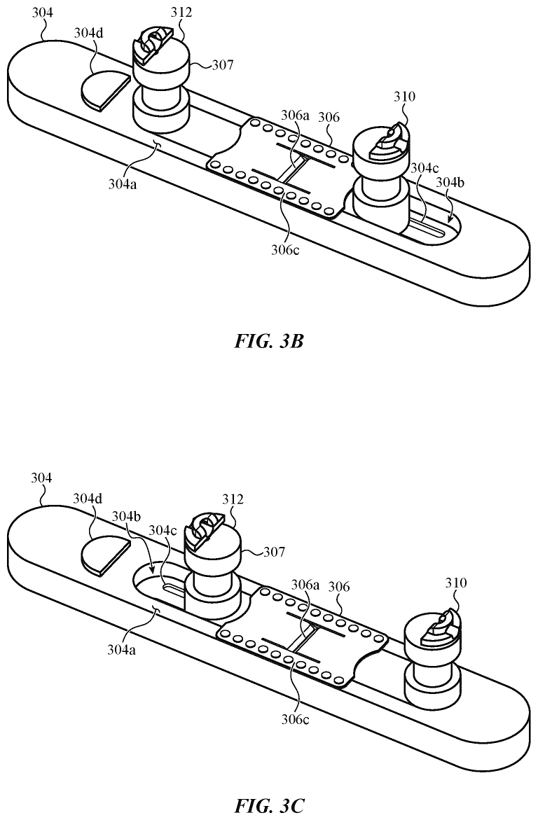

The slidable assembly 203 may additionally include a spring member 206. The spring member 206 may be configured to slidably retain the slidable assembly within the first position or within the second position. The spring member defines a protruding portion 206a which is configured to deform and/or deflect during the sliding motion. The deformation of the protruding portion 206a during sliding of the slidable assembly 203 (or more particularly, the fact that the protruding portion 206a must deform to allow the slidable assembly 203 to slide) produces a resistance force as the slidable assembly transitions to another position. In some cases, the spring member 206 may produce a tactile output in response to being moved from one position to the opposite position. For example, the spring member 206 may cause the slidable assembly 203 to click when engaging the first or the second position. In some cases, the spring member 206 inhibits the slidable assembly 203 from being stuck in an intermediate position by forcing the sliding assembly towards the first position or the second position. In some cases, the protruding portion 206a protrudes from the body of the spring member in a direction that is generally perpendicular to the sliding direction. The body of the spring member 206 is coupled to the button cap 204 (see FIG. 3B) to retain the button cap 204 to an actuation member 207, while also allowing the button cap 204 to slide relative to the actuation member 207.

The button assembly may include an actuation member 207. The actuation member 207 may include a cross member 208 and at least one post (e.g., posts 210 and 212, as shown). The cross member 208 may be positioned within the button cavity 202a and may be captured between the button cap 204 and the spring member 206. In some cases, the cross member 208 is fixed along the sliding direction of the slidable assembly 203 with respect to the housing 202 and is configured to be actuated (e.g., can move transversally) with respect to the housing 202 (e.g., perpendicular to the side surface of the housing 202 and/or the input surface of the button cap 204). The cross member 208 may also define a sliding surface along which a surface of the button cap 204 may slide during transitions between the first and second positions.

The first and second posts 210 and 212 may be coupled to opposite ends of the cross member 208. In some cases, the first and second posts 210 and 212 are perpendicular with respect to the cross member 208. In some examples, the spring member 206 is between the first post 210 and the second post 212.

In some examples, the cross member 208 may define a first retention feature 208a and a second retention feature 208b. Each the first and second retention features 208a-208b face the protruding portion 206a and are configured to engage with the protruding portions to retain the slidable assembly 203 in either the first position or the second position. In some cases, the retention features may be referred to as engagement features. For example, in a first position, the protruding portion 206a fits partially inside the first retention feature 208a, which may define a depression along the surface of the cross member. In a second position, as depicted in FIG. 2A, the protruding portion 206a fits partially inside the second retention feature 208b, which may define a depression formed along the surface of the cross member. In some embodiments, the first and second retention features 208a and 208b define rounded surfaces, with a transitional surface between the depressions. Between the first retention feature 208a and the second retention feature 208b an inflection region of the surface may be defined, which may have a sharper surface, an inflection, and/or a change in direction. Due to this configuration, the slidable assembly 203 may click or snap to either the first or the second position.

For example, when the button assembly 200a is in the second position, as shown in FIG. 2A, the protruding portion 206a is partially received within the second retention feature 208b. Because the undeformed state of the protruding portion 206a is a protruded configuration, this position represents a low preloading state of the spring member 206. As the slidable assembly 203 is slid from a second position (FIG. 2A) to a first position (FIG. 2B), the protruding portion 206a follows the general contour of the second retention feature 208a towards the transition point 208c. To follow this contour, the protruding portion 206a deforms, thereby storing potential energy in the spring member 206. As the protruding portion 206a approaches the transition point 208c, more energy is stored. As a user continues to apply a sliding force at the user interface surface 204a to slide the button cap 204, the protruding portion 206a clears the transition point 208c and snaps (e.g., is forced) to the first position (shown in FIG. 2B). The stored potential energy of the spring member 206 may cause the protruding portion 206a to snap to either retention feature; in this illustration, to the first position, where the protruding portion 206a is partially inserted at the first retention feature 208a of the cross member 208. Further, due to the retention force of the spring (e.g., the force needed to deform or deflect the spring member to release from the retention feature), a threshold sliding force applied to the button cap is required in order to toggle the slidable assembly to each position.

While the spring member 206 is depicted as a protrusion and the cross member 208 is depicted with depressions formed into the surface, it is envisioned that in other examples, the spring member may define a deformable depression configured to engage with the engagement features 208a-208b. In this example, the engagement features, may include protrusions and/or other structures (instead of depressions) that are configured to engage with one more depressions of the spring member. Generally, the spring member 206 defines a deformable portion that engages with engagement features to apply a retention force to the cross member and/or to snap to respective positions. More generally, the spring member 206 generally defines a detent system that defines multiple detent positions. Other types of detent systems may be employed, including but not limited to ball detents, pin detents, spring detents, pawls, and the like.

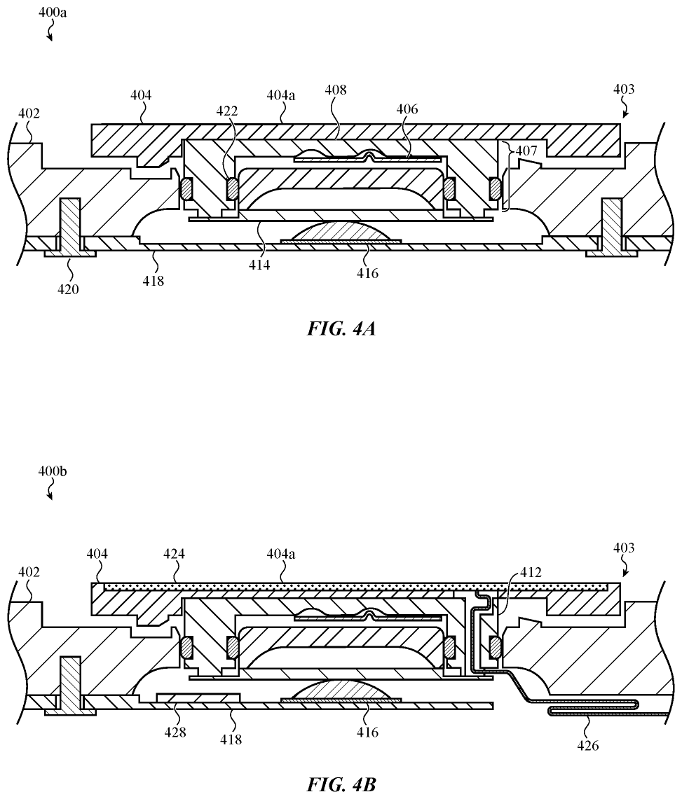

In some examples, the housing 202 defines a first opening 202d and a second opening 202e. The first post 210 may extend through the first opening 202d and the second post 212 may extend through the second opening 202e. In some examples, additional mechanical components may be within the housing 202 to secure the button assembly to the housing (e.g., as shown and described with respect to FIGS. 4A-4C. The first post 210 and the second post 212 are configured to transmit a press input force from the user input surface 204a to a switch or other electronic components within the housing (e.g., actuate the switch, or actuate the input button system more generally).

In the first position shown in FIG. 2A, the first and the second post cannot be actuated or pressed with respect to the housing because of one or more feature in the button cavity 202a and/or the button cap 204 inhibits its motion. For example, the button cap 204 may include a protrusion 204c. This protrusion 204c may prevent pressing of the button cap 204 with respect to the housing 202 due to contact with the bottom surface 202b. In some cases, the housing 202 may define protruding features which interface with an inside surface 204d of the button cap 204 and thus prevent downwards movement of the button cap 204 in the first position—thereby locking the button assembly 200a. Because the button cap 204 cannot be pressed, the actuation assembly likewise does not actuate. While one protrusion 204c is shown, in some examples, the button cap 204 may include multiple protrusions, to prevent skewed loading of the button assembly 200a during pressing.

FIG. 2B shows a plan view and a cross-sectional view of the button assembly 200b in the first position (e.g., the unlocked position). As depicted, upon a user applying a sliding force to the button cap (e.g., at the user input surface 204a), the sliding assembly—including the button cap 204 and the spring member 206—may move along a sliding direction 214 to the first position. At the first position, the button assembly 200b is actuatable. As depicted, the actuation member does not move along direction 214 with the sliding input. For example, the cross member 208, the first post 210, and the second post 212 are fixed along direction 214 with respect to the housing 202 during the sliding motion.

In some cases, as shown in the plan view, the housing 202 may include an indicator 216 which indicates to the user that the button is unlocked. The indicator 216 may be a coating, etching, stickers, materials having different colors, textures, or other visibly distinctive treatments or indicia, a hole, or an optically transmissive material where a light (e.g., an LED) shines through, or the like. Regardless of its configuration, the indicator 216 may be occluded in the locked position and visible in the unlocked position. As with the second position, in the first position, one ore more of the walls of the button cap 204 and the sidewall 202c of the housing 202 may define the travel distance of the button. In some examples, contact between the housing 202, the button cap 204, the first post 210, and/or the cross member 208, may prevent the button cap from sliding past a certain position.

When the button assembly 200b is in the first position, the protrusion 204c of the button cap 204 may align with a recess 202f defined by the housing 202. Due to this alignment, the protrusion 204c does not interfere with a bottom surface 202b of the housing, thereby enabling the button cap 204 to be actuated (e.g., allowing the button assembly to be moved along an input direction to actuate a switch element or other input detection system).

FIG. 2C shows the button assembly 200c in the actuated position. As depicted, a press input on the user input surface 204a along a transverse direction 218 (e.g., perpendicular to the input surface of the button cap) causes the button assembly 200c to be actuated. More specifically, the sliding assembly (e.g., the button cap 204 and the spring member 206) along with the actuation member (e.g., the cross member 208, the first post 210, and the second post 212) may move along direction 218 with respect to the housing 202. In the actuated position, the protrusion 204c of the button cap 204 may partially insert in the recess 202f, thereby allowing the button assembly to be actuated.

FIG. 3A shows an exploded view of a button assembly 300. This view shows an example configuration of the spring member. The button assembly 300 may include portions that are external or partially-external to a housing 302 of an electronic device. For example, the button assembly 300 includes a slidable assembly 303, including a button cap 304 and a spring member 306, and an actuation member 307 that includes a cross member 308, a first post 310, and a second post 312. To assemble, the cross member 308 is captured between the button cap 304 and the spring member 306. The spring member 306 is secured to the button cap 304 (e.g., via welding, fastening, or the like). The assembled button cap 304, spring member 306, and actuation member 307 is then positioned within a button cavity 302a defined by the housing 302. A portion of the first post 310 and the second post 312 are inserted into a first opening 302b and a second opening 302c, respectively, of the housing 302.

The spring member 306 may include a protruding portion 306a, which is defined by a central region 306b of the spring member 306. The central region 306b may be deformable to allow the slidable assembly to transition between positions. The central region 306b may be partially detached from a peripheral region 306c. For example, the spring member 306 may define slots on either side of the protruding portion 306a which increases the flexibility of the protruding portion 306a to enable it to deform around each respective depression of the actuation member 307 and/or the cross member 308. As described herein, the spring member 306 may be a monolithic piece formed from any suitable material, including metals such as stainless steel and aluminum, alloys, polymers, and the like. In some cases, the spring member 306 may be formed through any suitable method, including pressing, printing, machining, and the like.

FIG. 3B shows a partially-assembled, bottom view of the button assembly 300 in a first position and FIG. 3C depicts the bottom view of the button assembly 300 in a second position. As depicted in this view, the peripheral region 306c of the spring member 306 may be fixedly coupled with respect to an inside surface 304a of the button cap 304, opposite a user interface surface of the button cap 304. The spring member 306 may be welded to the button cap 304. Other techniques for fixing the spring member 306 to the button cap include fasteners, rivets, adhesives, and the like (including combinations of such fasteners/techniques).

As depicted in FIGS. 3B and 3C, in an assembled configuration, the cross member 308 may be inserted within a cavity 304b defined along a bottom of the button cap 304. Next, the spring member 306 is coupled to the button cap 304, thereby movably coupling the actuation member 307 with respect to the button cap 304 and to the spring member 306. In this example, the protruding portion 306a of the spring member 306 applies a force with respect to an inside surface of the cross member 308 that is parallel to the user interface surface and/or to the inside surface 304a.

The button cap 304 may additionally define channels 304c, which may be formed at a bottom end of the cavity 304b. The channel 304c may be configured to facilitate the sliding movement between the button cap 304 and the cross member 308. In some cases, the button assembly 300 includes a lubricant configured to decrease possible wear between the cross member 308 and the button cap 304 due to repeated sliding cycles. In some cases, the lubricant may additionally decrease a sliding resistance between the button cap 304 and the cross member 308. In other examples, the lubricant may be an electrically-conductive lubricant which electrically couples the button cap 304 to the actuation member 307. In this configuration, signals, such as an electrocardiogram (ECG) signal, a touch signal, and the like, may be received and transmitted to other electronic components within the device. For example, the ECG signal is received at the user input surface, travels through the button cap 304, through the lubricant, and through one more posts 310 and 312, and reaches a flex circuit or other electrical component coupled to via the posts 310 or 312.

As discussed in FIGS. 2A-2C, the button cap 204 may include one or more protrusions or features which interface with the housing to mechanically prevent the button assembly from translating. FIGS. 3B and 3C shows an example protrusion 304d for interfacing with the housing 302. Protrusion 304d may be proud from the inside surface 304a of the button cap 304.

Returning to FIG. 3A, the housing 302 may define a recess 302d at the bottom of the button cavity 302a which is configured to align with the protrusion 304d when the button assembly is in the first position (e.g., unlocked). Thus, in this position, the protrusion 304d partially inserts within the recess 302d when the button is pressed. The housing 302 may additionally include other features, such as raised portion 302e. In the second position, the raised portion 302e may be aligned (along an actuation direction) with respect to the button cavity 304b. Because of this alignment, the raised portion 302e does not prevent the button cap 304 from pressing. In the second position, the raised portion 302e may be aligned (along the actuation direction) with respect to the wall of the button cap 304. Thus, in response to a press input at the user input surface, the protrusion contacts the wall of the button cap 304, thereby preventing actuation of the button assembly 300.

FIG. 4A shows a cross-sectional view of an input button system 400a, including internal switch components. The input button system 400a may include all or some of the components from the button assembly described in FIGS. 2A-3B. In this example, the input button system 400a may include the slidable assembly 403, having a button cap 404 and a spring member 406, and an actuation member 407, having a cross member 408, a first post 410, and a second post 412. Here, the actuation member 407 is coupled to a force transfer plate 414 via the first post 410 and the second post 412. As shown in FIG. 4A, the force transfer plate 414 may be internal to the housing 402. The force transfer plate 414, in turn, contacts a dome switch 416. The dome switch 416 is configured to bias the button cap 404 and the actuation member 407 in a non-actuated (default, not pressed) position (e.g., via the force transfer plate).

The dome switch 416 may be coupled to a support structure 418 which, in turn, is coupled to the housing 402 via fasteners 420. In some embodiments, the support structure 418 may instead or additionally be coupled to the housing 402 via welding, adhesives, interlocking mechanical features, or any other suitable attachment technique. In response to a pressing input at a user input surface 404a, the dome switch 416 is configured to collapse and provide a haptic response. Upon the user releasing the input button system 400a, the dome switch restores the input button system 400a to the non-actuated position. Generally, the dome switch 416 collapses upon a threshold force being applied (e.g., by the force transfer plate 414). In some cases, the support structure 418 and/or the dome switch 416 may be electrically coupled to a flex circuit or other electrical circuit. The dome switch 416 may output a signal that causes an action to be performed in a user interface displayed by the electronic device. In some cases, the dome switch 416 may cause a vibration or other response to be output by the electronic device. While one dome switch 416 is shown, it should be understood that the input button system 400a may include multiple dome switches, which may provide distinct responses when different areas of the user input surface 404a are pressed. In some configurations, as shown, regardless of the location of the press input with respect to the user input surface 404a, the button cap translates uniformly due to its symmetrical arrangement. In some examples, the force transfer plate may have a mounted strain sensing system (e.g., a strain gauge). As the button is actuated, the force transfer plate may deform, thereby causing a change in potential output by the strain sensing system. The system may include a processor that is configured to determine force applied to the button assembly based on the change in potential detected.

In some cases, as depicted in FIG. 4A, the input button system 400a may be adapted to prevent water ingress. For example, the input button system 400a may include one or more O-rings 422. The O-rings may deform to create a waterproof or water-resistant shield against liquids, contaminants, and the like.

FIG. 4B shows a variation of an input button system 400b in which the button assembly from FIGS. 2A-2C may be incorporated. In this variation, the button cap 404 includes an electrical component layer 424 which defines at least a portion of the user input surface 404a (and optionally an entirety of the user input surface 404a). The electrical component layer 424 may be a touch sensing system, a display, an electrode, capacitive sensors, electrode layers below a cover, electrical assemblies, or the like. In some examples, the electrical component layer 424 may be configured to detect a touch input from a user. In some cases, the touch input may be a tap gesture, a swipe gesture, and the like. The touch sensing systems may be configured to determine a force applied to the surface, such as via capacitive sensing. In some examples, the electrical component layer 424 may be configured as an electrode and may receive a signal from a user's finger, such as an electrocardiogram (ECG) signal.

The electrical component layer 424 may be coupled to a flexible conductive element 426 (e.g., a flex circuit, a conductive plate, and the like). The flexible conductive element 426 may be configured to conductively couple the electrical component layer 424 to a processing system and/or to other electrical circuitry within the device. In some examples, the flexible conductive element 426 may be routed through a portion of the post 412. In response to sliding the slidable assembly 403, a portion of the flexible conductive element 426 may shift with the button cap 404 such that the button cap 404 can translate between the first and second positions while maintaining the electrical connection.

In some examples, the support structure 418 may be cantilevered with respect to one side of the input button system. In this configuration, the support structure 418 may have sufficient stiffness, thereby supporting the dome switch 416 when the button cap 404 is actuated. The support structure 418 may include a force sensing system 428. In some cases, the force sensing system 428 may include a strain sensor configured to output a signal corresponding to a deflection of the support structure 418. The force sensing system 428 may be coupled to the processing system of the electronic device which may output a graphical indicator in the display based on the force applied to the button cap 404 at the user input surface 404a.

FIG. 4C depicts a variation of an input button system 400c that may incorporate the button assembly from FIGS. 2A-2C. In this variation, the input button system 400c includes a solid state button configured to output a haptic response in response to a press input as well as detect a displacement corresponding to a force applied to the input button system 400c. The input button system 400c may include a flexible beam structure 430 that is suspended with respect to the support structure 432 via one or more fastening members 433a-433b. In some cases, the fastening members 433a-433b may be coupled to the housing 402. Upon receiving a press input (e.g., at the first position) at the button cap 404, the button cap 404 is configured to apply a force to the actuation member, including the first post 410 and the second post 412. The first post 410 and/or the second post 412 may cause the flexible beam structure 430 to deflect towards the support structure 432. Upon detecting the press input, a magnetic member 436, mounted on the flexible beam structure 430, may be configured to magnetically couple to the support structure 432 and release, thereby generating a haptic response to the press input. In some cases, the magnetic member 436 may be an electromagnet comprising coils which are configured to create a magnetic field, thereby magnetizing the magnetic member 436.

In some cases, the flexible beam structure 430 may include (or have mounted thereon) one or more force sensors 434 and 438. The force sensors 434 and 438 may be strain-based sensors that are configured to detect a deflection of the magnetic member in response to the press input. In some cases, the force sensors 434 and 438 may be distributed along a length of the magnetic member 430. Due to this configuration, the input button system 400c may be configured to detect a location of an input force with respect to the user interface surface 404a. For example, a press towards one end (e.g., left of the page) of the user interface surface may output a larger deflection for force sensor 434 and a lower deflection from force sensor 438. Accordingly, a processing system may determine a location based on the signal from each respective force sensor.

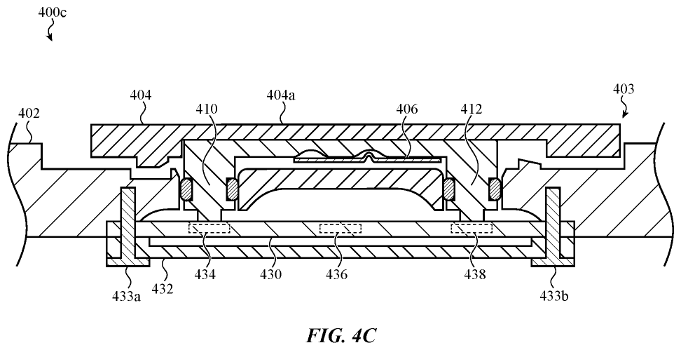

FIGS. 5A-5B depict an example input button system 500 having a position sensing system. The example input button system 500 may incorporate the components from the button assembly from FIGS. 2A-2C. FIG. 5A depicts the input button system 500 in the first position (unlocked) and FIG. 5B depicts the input button system 500 in the second position (locked). The position sensing system may include a sensing element 508 and tag 506 configured to be detected by the sensing element 508 at a predetermined range. As depicted, a button cap 504 may be coupled to a tag 506 positioned over a periphery of the button cap 504 and at a position adjacent to the housing 502. When the button cap is in a first position, as depicted in FIG. 5A, the tag 506 is outside a sensing range of a sensing element 508. When the button cap 504 is in the second position, as depicted in FIG. 5B, the tag 506 is within the sensing range of the sensing element 508. In this configuration, the different positions of the button cap 504 result in different outputs for the sensing element 508 and thus a processing system within the electronic device 100 can be configured to determine the position of the button cap 504 based on the output from the sensing element 508.

In some examples, a housing 502 of an electronic device (e.g., electronic device 100 from FIG. 1A), may be formed from metal. Due to this configuration, certain signals, such as a radio frequency identification (RFID) signal may be difficult to transmit. In the example shown, the housing 502 may include a non-metallic portion 510 positioned between a first portion 502a of the housing and a second portion 502b of the housing. In some cases, the non-metallic portion 510 may be formed via an injection molding process (such as low injection pressure overmolding (LIPO)). Generally, the non-metallic portion may be formed from a polymer, glass, glass ceramic, thermoplastics, and the like. The input button system 500 may include a sensing element 508 configured to detect a signal and/or detect a proximity of an object, such as tag 506, with respect to the sensing element 508. In some examples, the sensing element 508 may be an RFID reader. In other examples, the sensing element 508 may be an IR detector, optical detector, electrical detector, and/or other sensors or detectors that can be configured to detect a proximity of an object, such as a tag. The tag 506 is an object that can be detected by the sensing element 506. The sensing element 508 may be coupled to a processing system configured to determine the position of the button cap 504. The sensing element 508 may be positioned below or adjacent to the non-metallic portion 510 such that a signal may be transmitted across the housing 502 (e.g., through the non-metallic portion 510). The input button system 500 may include a tag 506 coupled to the button cap 504. The tag 506 may be configured to be detected by the sensing element 508 based on its proximity. In some examples, the tag 506 may be positioned at an end of the button cap 504, adjacent to the housing 502.

In the first position, as shown in FIG. 5A, the button cap 504 is in the first position and the tag 506 is over a metallic portion 502b of the housing 502. Due to this position, a signal from the tag 506 cannot transverse the housing 502 and thus the sensing element 508 does not detect the tag 504. Due to this position, the sensing element 508 may transmit a signal to the processing system indicating that the tag 506 is not in range. In turn, the processing system may determine that the button cap 504 is in the first position (e.g., unlocked).

In the second position, as shown in FIG. 5B, the button cap 504 is in the second position and the tag 506 is over the non-metallic portion 510 of the housing 502. Due to this position, the tag 506 can be detected through the non-metallic portion 510 and reach the sensing element 508. Thus, a sensing element 508, in turn, may transmit a signal indicating that the tag 506 is in range. The processing system then may determine that the button cap 504 is in the second position (e.g., locked). Each determination of the position of the button cap 504 may cause display of a graphical indicator in the display of the electronic device.

While in the example of FIGS. 5A-5B, the tag 506 is in range at the locked position, it should be appreciated that the location of the tag 506 and the sensing element 508 may be configured such that the tag 506 is in range at the unlocked position and out of range at the locked position. In some cases, the input button system 500 may include a sensing element/tag pair on opposite ends of the input button system 500 such that different tags are in range with respect to a respective sensing element, depending on the position of the button cap 504.

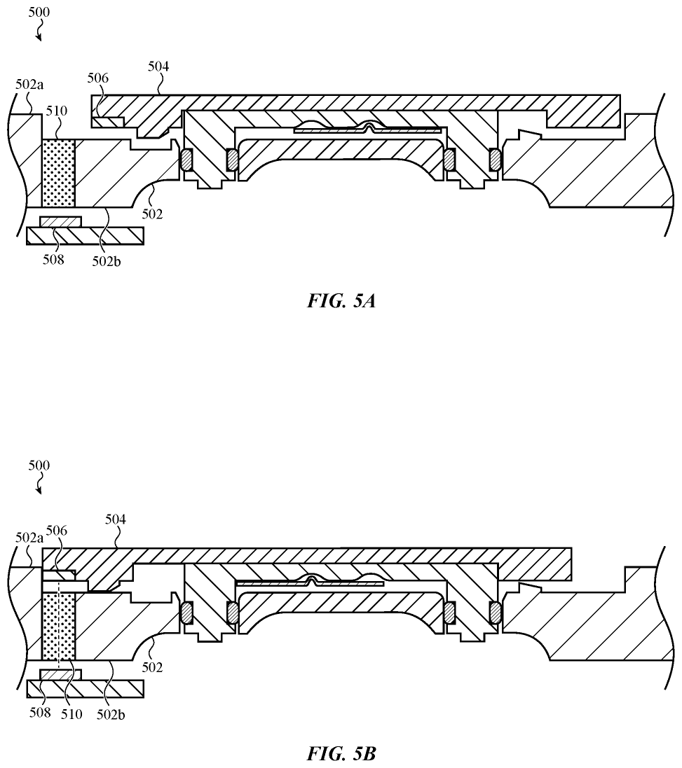

FIGS. 2A-5B illustrated above include a button assembly with two positions. In some examples, it is envisioned that the button assembly may include more than two positions. For example, the actuation member of the button assembly may include three or more engagement features that engage with the spring member of the slidable assembly. FIG. 6 shows a detail view of the interface of the spring member with respect to the actuation member including more than two positions. In this detail, the button assembly 600 includes a first position, a second position, and a third position that the slidable assembly 603 may click to. As depicted, an actuation member 607 may include a cross member 608 having respective retention features. For example, the cross member may include a first retention feature 608a, a second retention feature 608b, and a third retention feature 608c which are positioned at an internal surface 608d opposite a user interface surface 604a of a button cap 604. The spring member 606 is coupled to the button cap 604 (e.g., FIG. 3A) and applies a compressive force to the cross member 608. The spring member 606 may include a protruding portion 606a that engages either the first retention feature 608a, the second retention feature 608b, or the third retention feature 608c. More specifically, each of the retention features 608a-608c may define respective depressions that allow the protruding feature to move along the surface to engage and/or disengage each of the features. In some cases, the protruding member 606a deflects to conform to the surface and restores to an undeflected (or less deflected) shape at each of the retention features 608a-608c. In some cases, an inflection point between the two features may be narrower than the width of the protruding member 606a to promote snapping to either of the adjacent retention features. While three possible positions are shown, the button assembly may contain any number of discrete positions.

In some examples, each of the multiple positions may be actuatable and/or non-actuatable to cause different responses in the device. For example, the different positions may correspond to different functions like a camera function in one position, a video function in a second position, and a locked state corresponding to a third position. In some cases, the system may include position sensors, such as those described in FIGS. 5A-5B above to detect the position of the button assembly at each of these states.

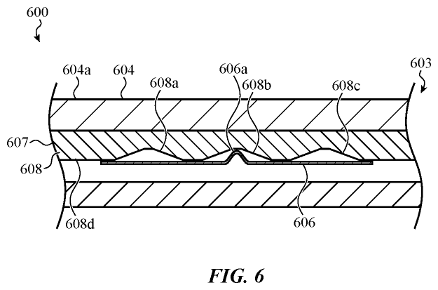

FIG. 7 shows a bottom view of an example button assembly 700 having a different detent structure as compared to those shown and described in FIGS. 2A-6. In this example, the button assembly includes multiple spring members 706 coupled along a wall of the button cap 704 and engaging with retention features 708a and 708b of a cross member 708 positioned along the side of the cross member 708. Unlike the examples presented in FIGS. 2A-6, where the spring member engages the cross member along a surface that is parallel to the user input surface, the spring members 706 engage sides of the cross member 708 that are perpendicular to the user input surface between posts 710.

More specifically, a button cap 704 may be fixedly coupled to the spring members 706. The cross member may be inserted in a cavity of the button cap 704, resulting in the spring members 706 being captured between the cross member 708 and the button cap 704. In this case, the button assembly may include one or more covers 714 to retain (e.g., in a transverse direction) the button cap 704 with respect to the cross member 708.

In some examples, the button cap 704 and the spring members 706 may be a monolithic piece. For example, the button cap 704 and the spring members 706 may be formed from a single unitary piece of material (e.g., metal, plastic, etc.). In other examples, the button cap 704 and the spring members 706 may be integrated in another way. For example, the button cap 704 and the spring members 706 may be overmolded (e.g., the spring members 706 may be placed in a mold cavity, and the button cap 704 may be molded around the spring members 706 such that the spring members 706 are at least partially encapsulated in the material of the button cap 704). In some cases, the spring member 706 may be formed from stamped sheet metal and the button cap 704 may be injection molded. In other variations, the button cap 704 and the spring member 706 may be formed via a three-dimensional printing process. For example, the button cap 704 and the spring member 706 may be formed via selective laser melting or direct metal laser sintering, though other manufacturing methods are envisioned.

In the first position, shown in FIG. 7, the spring members 706 may engage with retention features 708a. In some cases, the spring members 706 and the respective retention features 708a are positioned on opposite sides of the cross member 708. In some examples, the spring members 706 are positioned on a single side of the cross member 708. In yet other embodiments, the spring member 706 may be coupled to one side of the button cap 704 while being unrestrained on an opposite side. In this example, the spring member 706 may define a cantilevered structure. Due to this configuration, a length of the spring member may be reduced. More generally, the retention features may be depressions, slots, or similar geometries. In response to a slide input from a user, each spring member 706 disengages each respective retention feature 708a and transitions towards retention features 708b to arrive at the second position. As discussed above, the spring members 706 deflect around the surface of each of the retention features (e.g., the protruding portion between the features 708a, 708b) and may click or snap to a respective feature (e.g., the recess defined by the feature 708a,708b) in order to align the slidable assembly 703 in either the first or the second position. In some cases, the button assembly may include more than two spring member 706 to, for example, increase a sliding resistance. This button assembly 700 may be incorporated into any of the button assemblies discussed as to FIGS. 4A-4C.

While the spring member 706 is shown as coupled to the button cap 704, in some embodiments other detent structures are envisioned. For example, spring members 706 may be coupled along a wall of the cross member 708, and the button cap 704 may define retention features 708a and 708b which engage the spring members 706. In this variation, the operation of the button assembly 700 is similar to that described above.

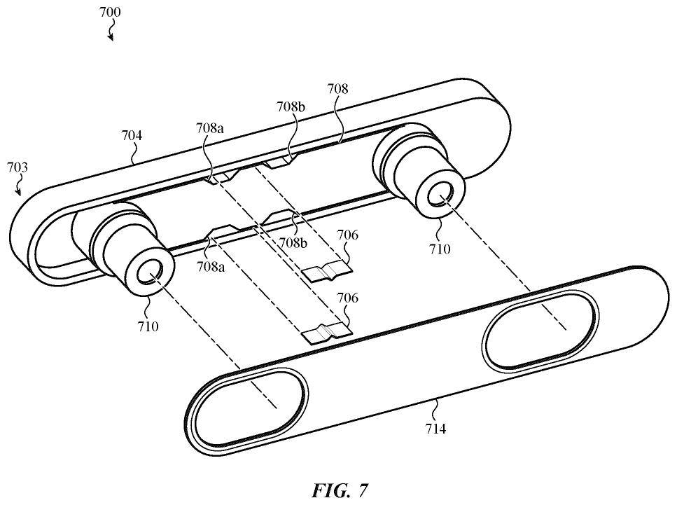

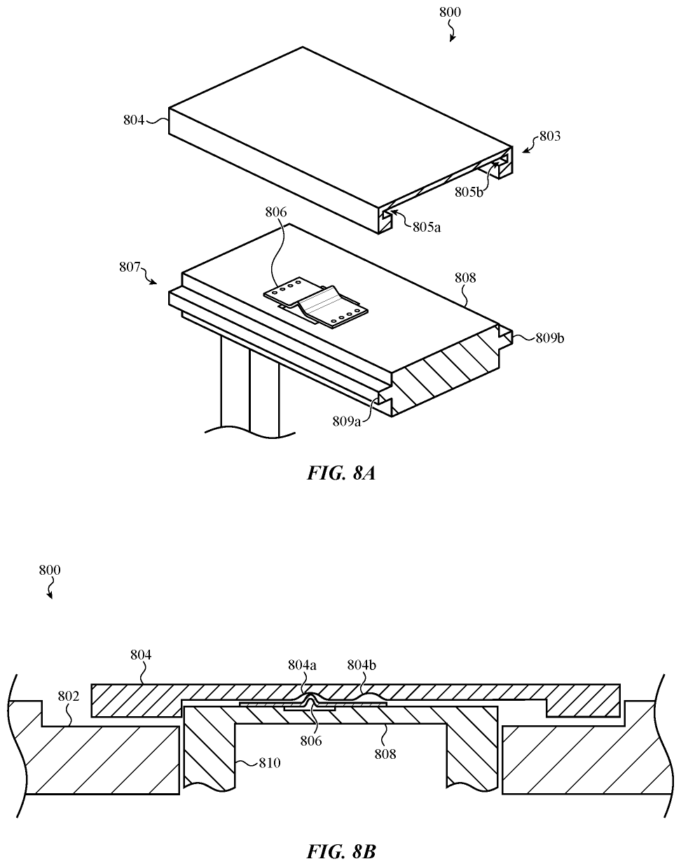

FIGS. 8A and 8B show an example button assembly 800 having another example detent structure. In this example, the spring member is coupled to the cross member (instead of the button cap) such that the button cap slides with respect to both the spring member and the cross member.

FIG. 8A shows a partially-exploded section view of the button assembly 800. As depicted, a spring member 806 may be coupled to the actuation member 807 at the cross member 806. As described above, the spring member may be welded, fastened, adhered, overmolded (e.g., at least partially encapsulated in the actuation member), or formed as a monolithic piece with the actuation member 807. The spring member 806 may include a protruding portion which is configured to deflect in order to engage and/or disengage retention features within slidable assembly. For example, the retention features may be formed on the button cap 804 (see FIG. 8B) at a surface opposite a user input surface. Because the spring member 806 in this example is coupled to the actuation member 807, the spring member 806 in this case does not capture (and thereby secure) the button cap 804 to the actuation member 807 at the cross member 808. Thus, in this embodiment, the button cap 804 may define recesses 805a-b which are configured to slidably couple with rails 809a-b defined by the cross member 808. This recess/rail interface allows the button cap 804 to slide with respect to the actuation member 807 while retaining the button cap 804 to the actuation member 807.

FIG. 8B shows a cross-sectional view of the button assembly 800. Similar to the views shown in FIG. 2A-2C, the actuation member 807 may include posts 810 that extend through the housing 802 and interface with a switch (e.g., a dome switch, omitted from this view) to actuate the button assembly 800. The button cap 804 can slide to lock and/or unlock the button assembly 800 (e.g., by interfacing with portions of the housing 802, as described above). As shown in this figure, the spring member 806 remains static (e.g., with respect to the housing), while the button cap 804—along with retention features 804a-b—move relative to the housing. The spring member 806 disengages and engages the retention features 804a-b to snap the button cap 804 in particular positions (e.g., locked and unlocked).

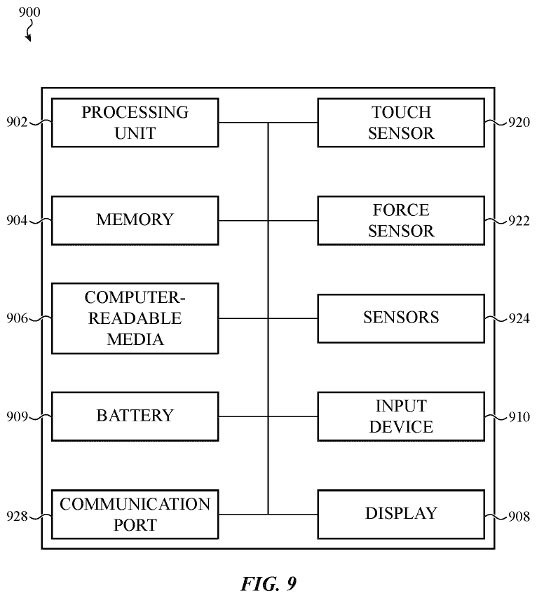

FIG. 9 depicts an example schematic diagram of an electronic device 900. The device 900 of FIG. 9 may correspond to the electronic device 100 shown in FIG. 1 (or any other wearable electronic device described herein). To the extent that multiple functionalities, operations, and structures are disclosed as being part of, incorporated into, or performed by the device 900, it should be understood that various embodiments may omit any or all such described functionalities, operations, and structures. Thus, different embodiments of the device 900 may have some, none, or all of the various capabilities, apparatuses, physical features, modes, and operating parameters discussed herein.

As shown in FIG. 9, a device 900 includes a processing unit 902 operatively connected to computer memory 904 and/or computer-readable media 906. The processing unit 902 may be operatively connected to the memory 904 and computer-readable media 906 components via an electronic bus or bridge. The processing unit 902 may include one or more computer processors or microcontrollers that are configured to perform operations in response to computer-readable instructions. The processing unit 902 may include the central processing unit (CPU) of the device. Additionally or alternatively, the processing unit 902 may include other processors within the device including application specific integrated chips (ASIC) and other microcontroller devices.

The memory 904 may include a variety of types of non-transitory computer-readable storage media, including, for example, read access memory (RAM), read-only memory (ROM), erasable programmable memory (e.g., EPROM and EEPROM), or flash memory. The memory 904 is configured to store computer-readable instructions, sensor values, and other persistent software elements. Computer-readable media 906 also includes a variety of types of non-transitory computer-readable storage media including, for example, a hard-drive storage device, a solid-state storage device, a portable magnetic storage device, or other similar device. The computer-readable media 906 may also be configured to store computer-readable instructions, sensor values, and other persistent software elements.

In this example, the processing unit 902 is operable to read computer-readable instructions stored on the memory 904 and/or computer-readable media 906. The computer-readable instructions may adapt the processing unit 902 to perform the operations or functions described herein. In particular, the processing unit 902, the memory 904, and/or the computer-readable media 906 may be configured to cooperate with a sensor 924 (e.g., a rotation sensor that senses rotation of a crown component) to control the operation of a device in response to an input applied to a crown of a device (e.g., the crown 112 or any other crown described herein). The computer-readable instructions may be provided as a computer-program product, software application, or the like.

As shown in FIG. 9, the device 900 also includes a display 908. The display 908 may include a liquid-crystal display (LCD), organic light emitting diode (OLED) display, light emitting diode (LED) display, or the like. If the display 908 is an LCD, the display 908 may also include a backlight component that can be controlled to provide variable levels of display brightness. If the display 908 is an OLED or LED type display, the brightness of the display 908 may be controlled by modifying the electrical signals that are provided to display elements. The display 908 may correspond to any of the displays shown or described herein.

The device 900 may also include a battery 909 that is configured to provide electrical power to the components of the device 900. The battery 909 may include one or more power storage cells that are linked together to provide an internal supply of electrical power. The battery 909 may be operatively coupled to power management circuitry that is configured to provide appropriate voltage and power levels for individual components or groups of components within the device 900. The battery 909, via power management circuitry, may be configured to receive power from an external source, such as an AC power outlet. The battery 909 may store received power so that the device 900 may operate without connection to an external power source for an extended period of time, which may range from several hours to several days.

In some embodiments, the device 900 includes one or more input devices 910. An input device 910 is a device that is configured to receive user input. The one or more input devices 910 may include, for example, a crown input system (e.g., any of the crowns described herein), a push button, a touch-activated button, a keyboard, a keypad, or the like (including any combination of these or other components). In some embodiments, the input device 910 may provide a dedicated or primary function, including, for example, a power button, volume buttons, home buttons, scroll wheels, and camera buttons.

The device 900 may also include one or more sensors 924. The sensors 924 may detect inputs provided by a user to a crown of the device (e.g., the crown 112 or any other crown described herein). The sensors 924 may include sensing circuitry and other sensing components that facilitate sensing of rotational motion of a crown, as well as sensing circuitry and other sensing components (optionally including a switch) that facilitate sensing of translational and/or axial motion of the crown (or axial force applied to the crown). The sensors 924 may include components such as an optical sensing unit, a tactile or dome switch, or any other suitable components or sensors that may be used to provide the sensing functions described herein. The sensors 924 may also include a biometric sensor, such as a heart rate sensor, electrocardiograph sensor, temperature sensor, or any other sensor that conductively couples to the user and/or to the external environment through a crown input system, as described herein. In cases where the sensors 924 include a biometric sensor, it may include biometric sensing circuitry, as well as portions of a crown that conductively couple a user's body to the biometric sensing circuitry. Biometric sensing circuitry may include components such as processors, capacitors, inductors, transistors, analog-to-digital converters, or the like.

The device 900 may also include a touch sensor 920 that is configured to determine a location of a touch on a touch-sensitive surface of the device 900 (e.g., an input surface defined by the display). The touch sensor 920 may use or include capacitive sensors, resistive sensors, surface acoustic wave sensors, piezoelectric sensors, strain gauges, or the like. In some cases, the touch sensor 920 associated with a touch-sensitive surface of the device 900 may include a capacitive array of electrodes or nodes that operate in accordance with a mutual-capacitance or self-capacitance scheme. The touch sensor 920 may be integrated with one or more layers of a display stack (e.g., the display) to provide the touch-sensing functionality of a touchscreen. Moreover, the touch sensor 920, or a portion thereof, may be used to sense motion of a user's finger as it slides along a surface of a crown, as described herein.

The device 900 may also include a force sensor 922 that is configured to receive and/or detect force inputs applied to a user input surface of the device 900. The force sensor 922 may use or include capacitive sensors, resistive sensors, surface acoustic wave sensors, piezoelectric sensors, strain gauges, or the like. In some cases, the force sensor 922 may include or be coupled to capacitive sensing elements that facilitate the detection of changes in relative positions of the components of the force sensor (e.g., deflections caused by a force input). The force sensor 922 may be integrated with one or more layers of a display stack to provide force-sensing functionality of a touchscreen.

The device 900 may also include a communication port 928 that is configured to transmit and/or receive signals or electrical communication from an external or separate device. The communication port 928 may be configured to couple to an external device via a cable, adaptor, or other type of electrical connector. In some embodiments, the communication port 928 may be used to couple the device 900 to an accessory, including a dock or case, a stylus or other input device, smart cover, smart stand, keyboard, or other device configured to send and/or receive electrical signals.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A mobile phone comprising:
a housing defining a side surface of the mobile phone; and
an input button system positioned along the side surface of the housing and configured to receive an input force, the input button system comprising:
a button assembly comprising:
an actuation member comprising:
a post extending through the housing; and
a cross member coupled to the post, the cross member defining a first retention feature and a second retention feature; and
a slidable assembly coupled to the actuation member and configured to slide, relative to the actuation member, between a first position in which the input button system is actuatable in response to the input force and a second position in which the input button system is inhibited from actuating in response to the input force, the slidable assembly comprising:
a button cap defining a user input surface of the button assembly; and
a spring member coupled to the button cap and defining a protruding portion configured to:
engage with the first retention feature of the actuation member to releasably retain the slidable assembly in the first position; and
engage with the second retention feature of the actuation member to releasably retain the slidable assembly in the second position.

2. The mobile phone of claim 1, wherein:
the housing defines a button cavity having a bottom surface;
the button cap, the spring member, and the cross member are positioned at least partially within the button cavity;
the bottom surface of the button cavity defines a recess;
the button cap defines a protrusion;
actuation of the input button system corresponds to a translational input; and
at the first position, the protrusion is configured to:
interfere with the bottom surface to inhibit translation; and
align with the recess to allow translation.

3. The mobile phone of claim 1, wherein:
the cross member defines a first end and a second end;
the button cap defines a wall extending about an outer periphery of the cross member;
at the first position, the wall abuts the first end of the cross member and defines a first gap with respect to the second end of the cross member; and
at the second position, the wall abuts the second end of the cross member and defines a second gap with respect to the first end of the cross member.

4. The mobile phone of claim 3, wherein:
the button cap defines a sliding surface opposite a user interface surface; and
the cross member is captured between the sliding surface and the spring member.

5. The mobile phone of claim 1, wherein:
the first retention feature defines a first depression;
the second retention feature defines a second depression;
in the first position, the protruding member engages with the first depression;
the protruding member is configured to deform along a surface defined between the first and second depressions of the cross member during a sliding motion; and
in the second position, the protruding member engages with the second depression.

6. The mobile phone of claim 5, wherein:
in response to a threshold sliding force applied to the button cap, the slidable assembly is configured to slide from the first to the second position, the sliding including causing the protruding member to disengage from the first depression and to engage the second depression.

7. The mobile phone of claim 5, wherein:
the protruding member is positioned at a central region of the spring member; and
the spring member is welded to the button cap.

8. An electronic device comprising:
a housing; and
a button assembly positioned along a side of the housing and comprising:
an actuation member configured to actuate a switch internal to the housing; and
a slidable assembly positionable in a first position in which the button assembly is translatable with respect to the housing and a second position in which the button assembly is non-translatable with respect to the housing, the slidable assembly configured to slide between the first position and the second position and comprising:
a button cap positioned over the actuation member; and
a spring member fixed to the button cap and configured to apply a retention force to the actuation member to resist motion of the slidable assembly between the first position and the second position.

9. The electronic device of claim 8, wherein:
the button cap defines a user input surface configured to receive a sliding force; and
the actuation member comprises a cross member defining:
a first retention feature configured to releasably engage with the spring member in the first position; and
a second retention feature configured to releasably engage with the spring member in the second position; and
the spring member is configured to disengage the first retention feature of the cross member at the first position and engage the second retention feature of the actuation member at the second position in response to the sliding force exceeding a threshold retention force between the spring member and the first retention feature.

10. The electronic device of claim 8, wherein:
the actuation member comprises:
a post operable to actuate a dome switch within the housing; and
a cross member coupled to the post; and
the cross member is captured between the button cap and the spring member.

11. The electronic device of claim 10, wherein:
the cross member releasably retains the spring member in either the first position or the second position; and
the spring member is configured to produce a tactile output in response to being moved from the first position to the second position.

12. The electronic device of claim 11, wherein the cross member is fixed along a sliding direction with respect to the housing.

13. The electronic device of claim 8, further comprising:
a position sensing system comprising:
a tag coupled to the button cap; and
a sensing element positioned within the housing and configured to detect a position of the button cap based at least in part on a position of the tag relative to the sensing element.

14. The electronic device of claim 13, wherein:
the position sensing system is operably coupled to a processor; and
in response to the sensing element detecting the position of the button cap, the processor is configured to cause display of a graphical indicator in a display of the electronic device.

15. A mobile electronic device comprising:
a housing defining an opening; and
a button assembly comprising:
an actuation member configured to actuate a switch internal to the housing, the actuation member comprising:
a post extending through the opening; and
a cross member defining a first engagement feature and a second engagement feature; and
a slidable assembly slidable between a first position and a second position and coupled to the actuation member, the slidable assembly comprising:
a button cap defining a user input surface and slidably coupled to the cross member, the button cap configured to:
when the slidable assembly is in the first position, cause the actuation member to actuate the switch in response to a force input at the user input surface; and
when the slidable assembly is in the second position, prevent actuation of the actuation member in response to the force input at the user input surface; and
a spring member slidably coupled to the button cap and defining a protruding portion configured to releasably couple to:
the first engagement feature when the slidable assembly is in the first position; and
the second engagement feature when the slidable assembly is in the second position.

16. The mobile electronic device of claim 15, wherein:
the button assembly is bistable; and
the spring member is configured to snap the button cap to either the first position or the second position.

17. The mobile electronic device of claim 15, wherein:
in response to a sliding input at the user input surface to transition from the first position to the second position, the protruding portion is configured to deflect to disengage the first engagement feature and restore to engage the second engagement feature.

18. The mobile electronic device of claim 15, wherein:
the button cap defines a channel opposite a user interface surface;
the cross member extends into the channel; and
the mobile electronic device further comprises a lubricant at least partially filling the channel and lubricating an interface between the cross member and the button cap.

19. The mobile electronic device of claim 15, wherein:
the button assembly is positioned within a button cavity defined by the housing; and
a bottom surface of the button cavity defines a raised portion configured to prevent the button cap from pressing in the second position.

20. The mobile electronic device of claim 15, wherein:
the mobile electronic device further comprises a flex circuit;
the button cap comprises an electronic component layer configured to detect an input from a user;
the electronic component layer is operably coupled to the flex circuit; and
the flex circuit is configured to receive a signal from the electronic component layer.
